(19) United States
(12) Patent Application Publication
(10) Pub. No.: US 2016/0265428 A1
(43) Pub. Date: Sep. 15, 2016

(54) ROTARY PISTON ENGINE WITH EXTERNAL EXPLOSION/EXPANSION CHAMBER

(71) Applicant: Chris Kiarash Montebello, Trondheim (NO)

(72) Inventor: Chris Kiarash Montebello, Trondheim (NO)

(21) Appl. No.: 15/028,168

(22) PCT Filed: Apr. 2, 2014
(86) PCT No.: PCT/DK2014/000009

§ 371 Date: Apr. 8, 2016

(30) Foreign Application Priority Data
Oct. 22, 2013 (NO) 201314000

(51) Int. Cl. F02B 57/10; F01B 3/00

(52) U.S. Cl. CPC F02B 57/10; F01B 3/0035; F01B 3/0085; F01B 3/0091

(57) ABSTRACT

A rotary piston engine with external combustion/expansion chamber is disclosed. According to an aspect, a rotary piston engine includes an intake cylinder/piston block to press air/medium toward a combustion/expansion chamber. The cylinder/piston block includes cylinders, pistons and piston rods. Connected to the cylinder/piston block is a converter wheel, which converts piston movement to rotation of the converter wheel and rotation of the cylinder/piston block. The rotation angle of the converter wheel is different than that of the cylinder/piston block such that the distance between pistons and converter wheel varies according to the displacement. The piston rods are able to displace at the converter wheel in 2 different directions, both going around the converter wheel and sideways compared to the converter wheel. The cylinder/piston block and the converter wheel have the same rotation speed, why all two parts are connected to each other with cogwheels and rods to maintain synchronization.

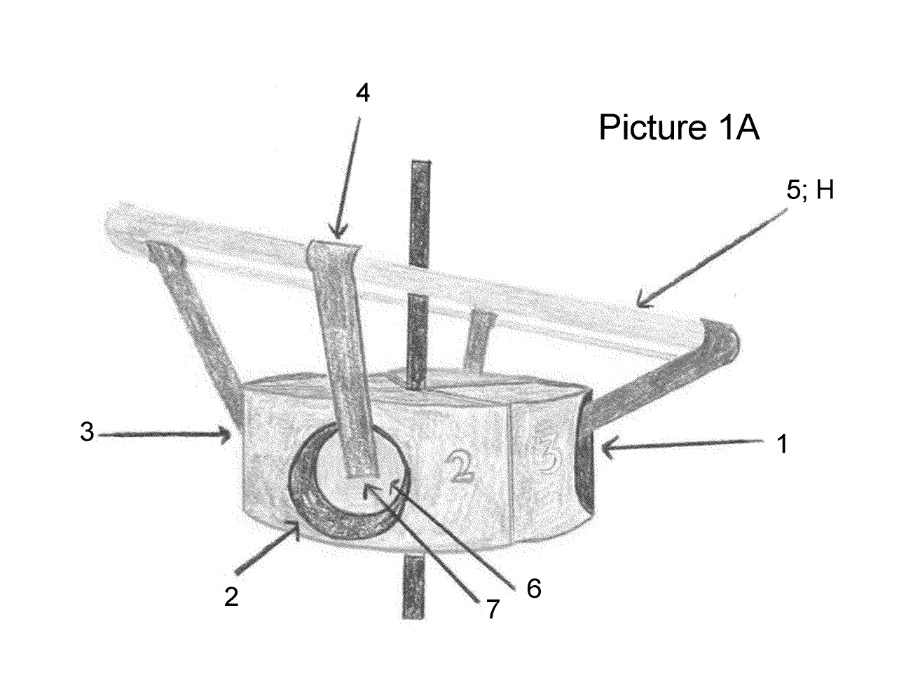

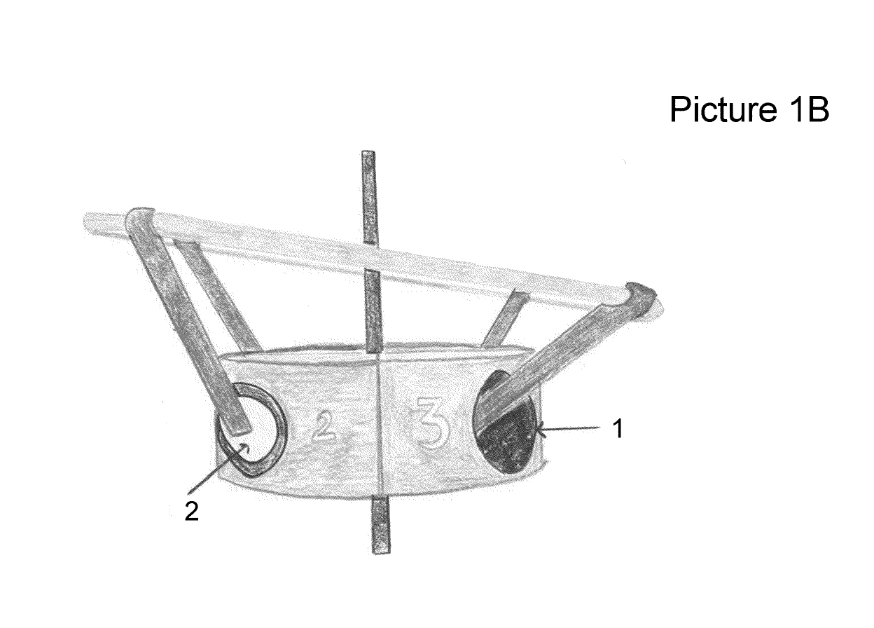

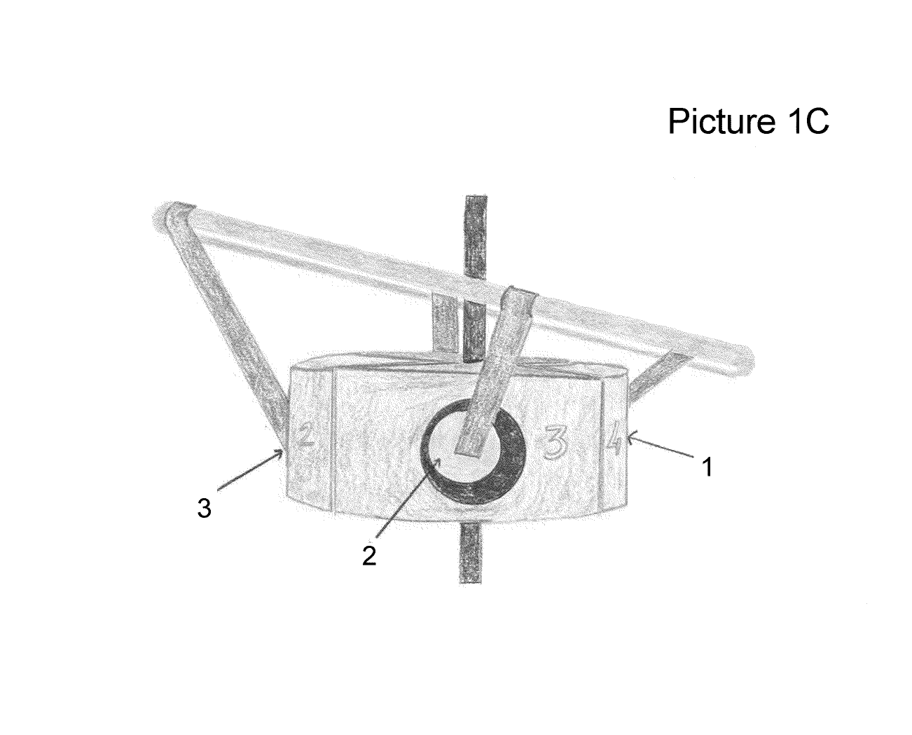

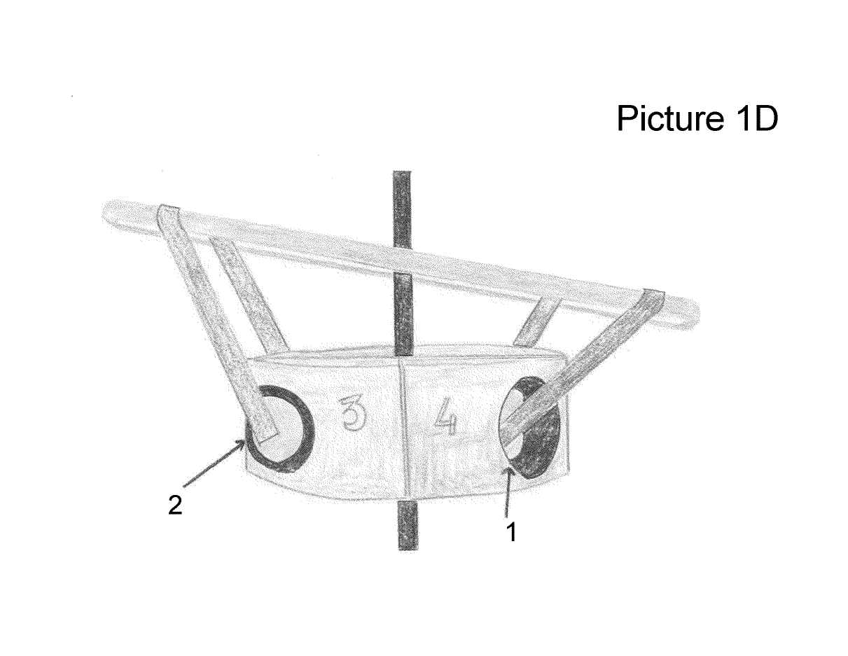

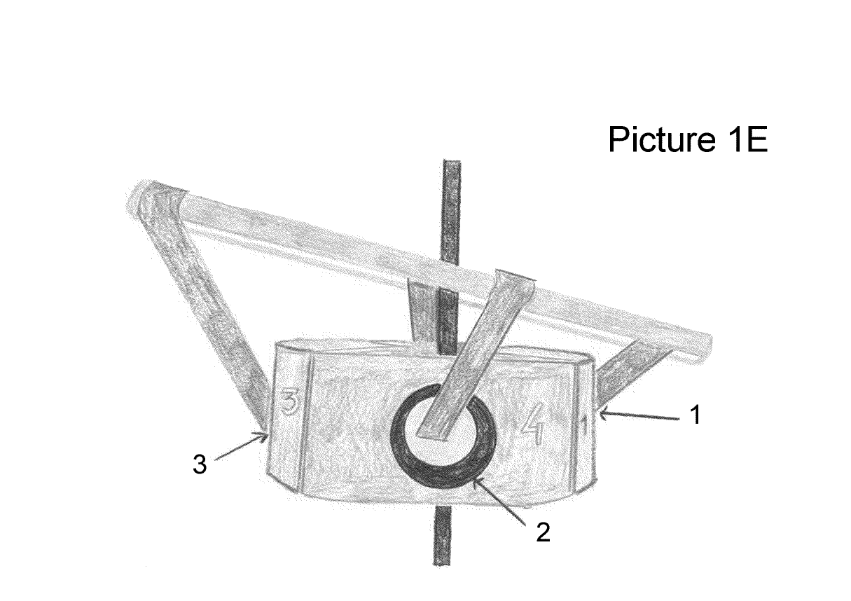

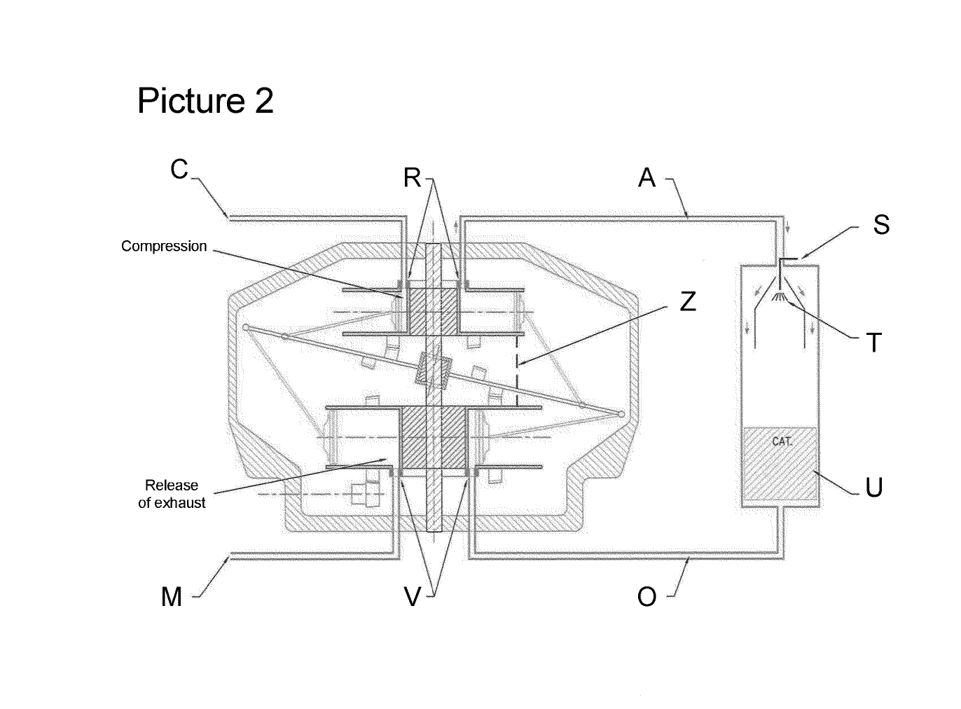

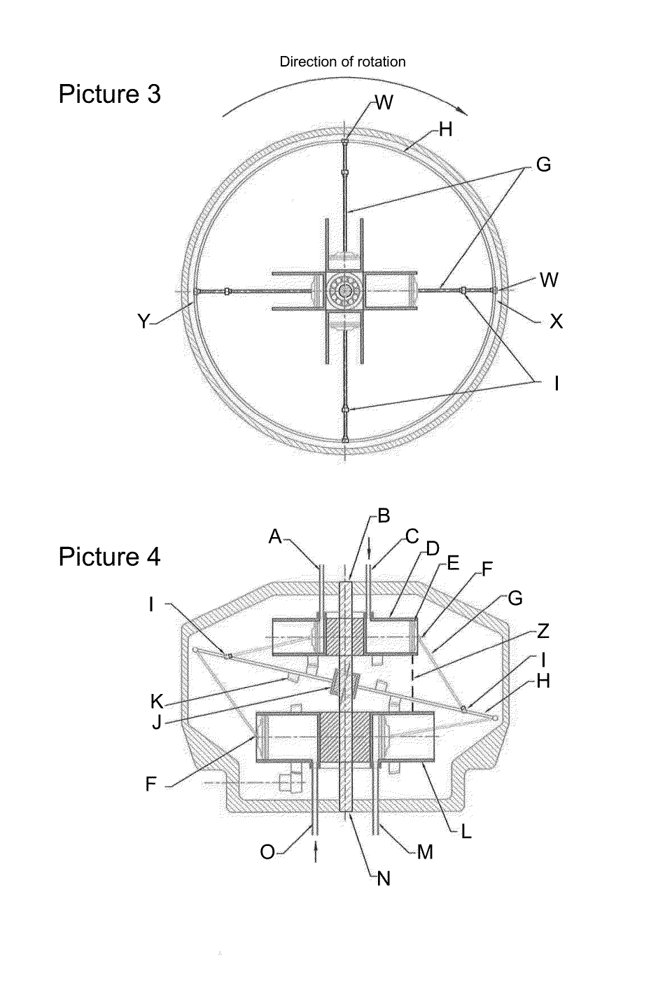

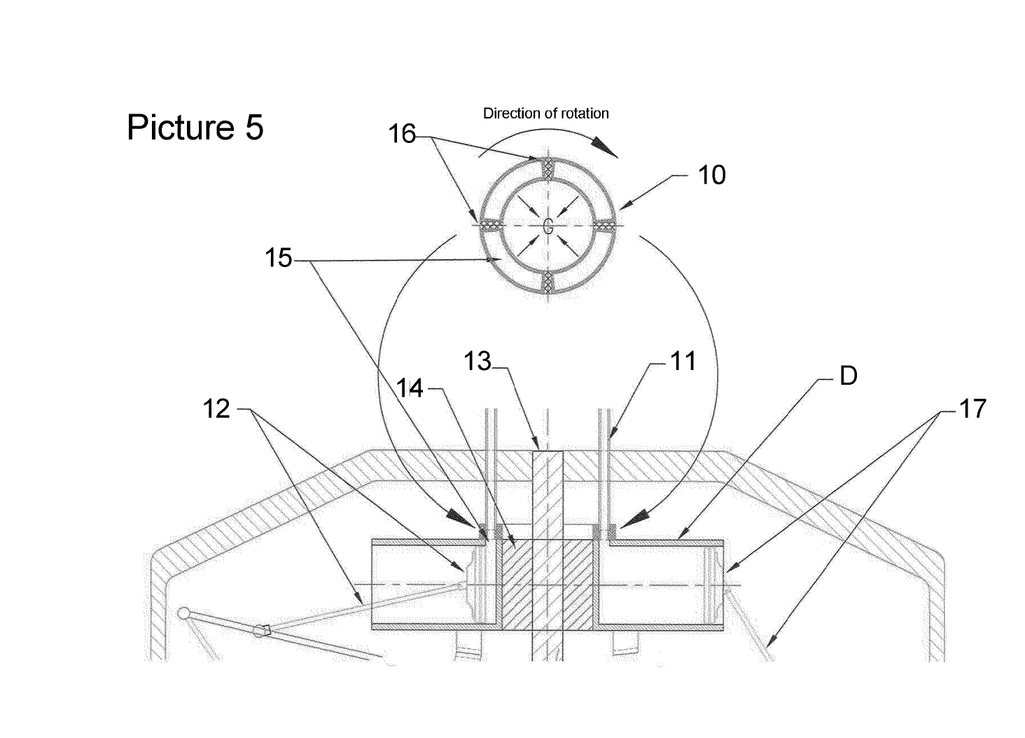

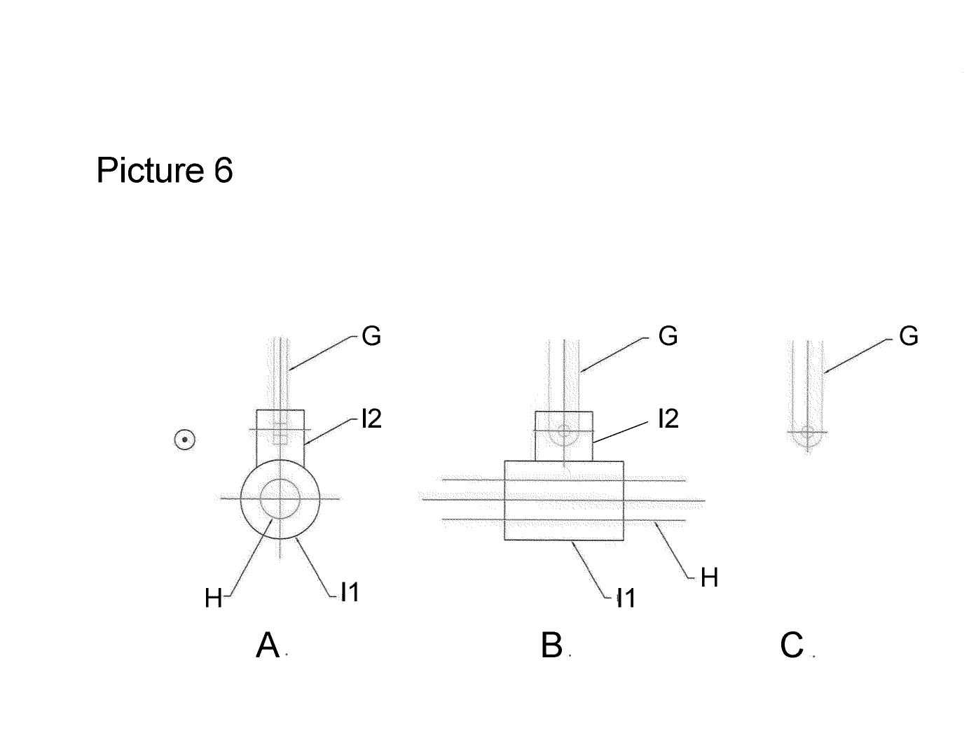

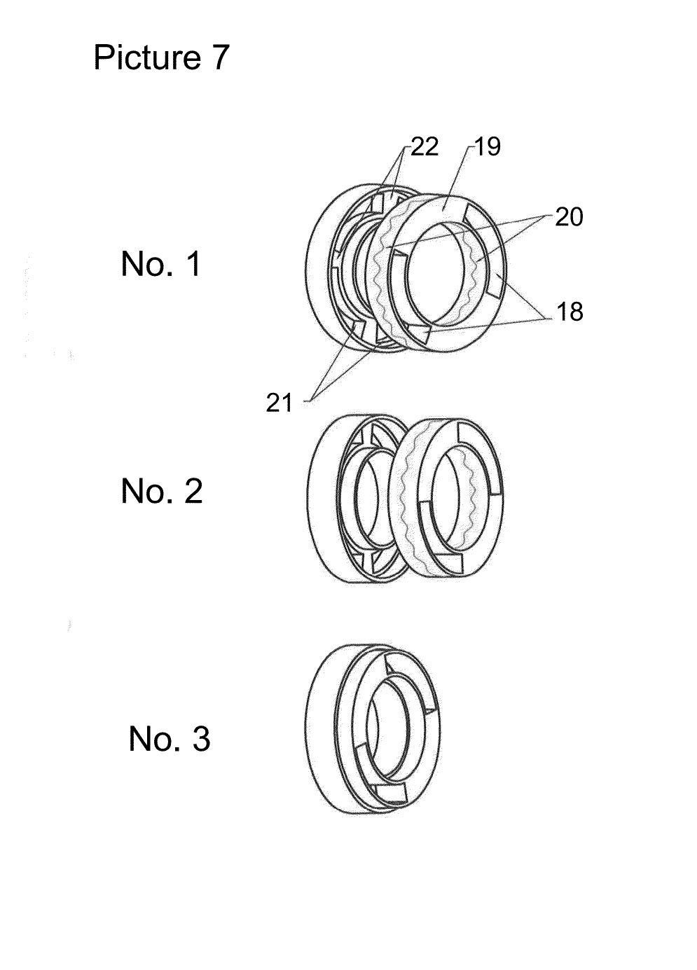

### CROSS REFERENCE TO RELATED APPLICATIONS

This application is a 35 USC 371 application of International Patent Application No. PCT/DK2014/000009, filed on Apr. 2, 2014, which claims priority to Nordic Patent Application No. 201314000, filed Oct. 22, 2013; all of the contents of which are hereby incorporated by reference herein in their entireties.

### SUMMARY

This is an engine where Cylinder/piston blocks and Converter wheel rotate around a Main Rotation axle with the same rotation speed. Number of the cylinders/pistons and stroke volume will vary according to the demands required of the engine. Between Cylinder/piston blocks there is a Converter wheel, which converts piston movement to rotation of Converter wheel and rotation of Cylinder/piston blocks.

The pistons are round and isolated with tightening rings around them. All of the pistons are sitting in their cylinders and Cylinder/piston blocks rotate around the same Main Rotation axle (for each part) on ball bearings.

The engine has in this case one Cylinder/piston Block to press the air/medium toward the combustion/expansion chamber. And another Cylinder/piston Block to harvest the energy from the reaction taking place in the Combustion/expansion chamber. There is a continuously combustion/expansion before or in the catalyzator (if a fuel is used), passage through catalyzator makes the combustion 100% efficient.

The expanded gases/medium then pass through manifold to the Exhaust Cylinder/piston block which has X times larger stroke volume compare to Intake Cylinder/piston, to extract surplus of energy.

Converter wheel is the one of the features of this engine. It is round; circle formed and goes around the same Main Rotation axel as Cylinder/piston blocks. Because the rotation angle of Converter wheel is different than the Cylinder/piston blocks, it means the distance between pistons and Converter wheel varies, according to the displacement.

Since the piston rod is sitting on the Converter wheel with another rotation angle, it must be able to displace at the Converter wheel in 2 different directions, both going around the Converter wheel and sideways compare to Converter wheel, in order to maintain contact and not to break.

The Converter wheel is stable on its rotation axel and does not move in other directions. When Converter wheel rotates, accordingly rotates Cylinder/piston blocks, and the Piston Rods push and pull the pistons in the cylinders.

The distance of the Converter wheel to the pistons in the Intake Cylinder/piston block (rotation diameter) is less than the distance of the Converter wheel to the cylinders in the Exhaust Cylinder/ block, in order to have the different power ratio. This is to keep the engine going in one direction. (Therefore in the engine, piston rods of the different Cylinder/piston blocks have different lengths)

### Page 2

Cylinder/piston blocks and Converter wheel in the engine have to have the same rotation speed, why all 3 parts are connected to each other with cogwheels and rods to maintain a perfect synchronization.

The Male manifolds that are sitting in the Female manifolds are tightened with tightening rings that are sinus formed in order to better lubricate the joint and give less metal destruction.

The weakest parts of the engine are probably the manifolds, which are not perfectly tight, but since the engines other parts are so few and nicely put together and not much power is lost, this engine will provide at least 50%-60% efficiency, if not more.

Furthermore the engine is volume based and not pressure based, hereby not like a 4 stroke engine.

Since the engine is rotary, it will be very small and not heavy and will provide much power. A rotary engine has the possibility of high rampage, and hence producing much power even if small. The external combustion will be able to burn almost all sort of combustible fuels, included natural gases, low grade fuels and even heat transmission in order to expand air or other mediums.

The arrangement of Cylinder/piston block and Converter wheel can also be used in different pumps, refrigerators, freezers, hydraulic pumps and everywhere else, when there is a need of transportation of fluids and gasses.

### BRIEF DESCRIPTION OF DRAWINGS

Pictures 1A to 1E

This series of pictures just show how one Cylinder/piston block rotates with the Converter wheel. Some details are missing and this is only to understand the mechanism of the rotation. The joint that moves sideways just before Converter wheel on piston rod is missing

Picture 1A

1—Number 3 piston maximum (of the cylinder length =OCL)inside the cylinder number 3

2—Number 2 piston 50% (of the cylinder length) inside the cylinder number 2

3—Number 1 piston maximum distance from the center with maximum stroke volume

4—Joint between Piston Rod and Converter wheel

5—Converter wheel H

6—Surface of piston number 2 half way OCL inside cylinder number 2

7—Joint between piston number 2 and Piston Rod
Picture 1B, after ⅛ of rotation (45 degree of rotation)

1—Piston number 3 is % of the cylinder length inside the cylinder 3

2—Piston number 2 is ¼ OCL inside the cylinder 2
Picture 1C, after ⅛ of rotation (45 degree of rotation)

1—Piston number 4 is 100% OCL inside cylinder number 4

2—Piston number 3 is 50% OCL inside cylinder number 3

3—Piston number 2 is in maximum distance from the center and with maximum stroke volume
Picture 1D, after ⅛ of rotation (45 degree of rotation)

1—Piston number 4 is % OCL inside cylinder number 4

2—Piston number 3 is ¼ OCL inside cylinder number 3
Picture 1E, after ⅛ of rotation (45 degree of rotation)

1—Piston number 1 is 100% OCL inside cylinder number 1

2—Piston number 4 is 50% OCL inside cylinder number 4

3—Piston number 3 is in maximum distance from center, with maximum stroke volume
Picture 2—English
Overview picture of the whole engine

C—Intake of fresh air/medium to Intake Cylinder/piston block

R—Intake of air/medium and compressed air/medium leaving from Cylinder/piston block, through manifold

A—Compressed air/medium to Combustion/expansion chamber

S—Injection of fuel, heating op, or inject of liquid gases and etc

T—Combustion of fuel/expansion of gases/medium

U—Catalyzator if fuel is used

V—Expanded gases/medium to/from Exhaust Cylinder/piston block through manifold.

M—Exhaust leaving the engine

O—Expanded gases/medium to Exhaust Cylinder/piston block

Z—Stabilizing rod between Cylinder/piston blocks to insure synchronized rotation
Picture 3, English
Cylinder/piston Block, cut through top view. Showing ball bearing and rotation mechanism

G—Piston rod

W—Joint between Piston rod of the Exhaust Cylinder/piston block and Converter wheel (details in picture 5)

H—Converter wheel

X—Converter wheel with longest Vertical distance from Cylinder/piston block. The picture is confusing, since it is a picture from above

Y—Converter wheel with shortest distance to Cylinder/piston block

I—Joint between Piston rod of Intake Cylinder/piston block and Converter wheel. The rotation diameter here is less than the rotation diameter of W. This picture is only to show the rotation diameter comparison of the different piston rod lengths.
Picture 4, English

A—Compressed air to Combustion/expansion chamber

B—Main Rotation axle

C—Fresh air to intake manifold, to Intake Cylinder/piston block

D—Intake Cylinder/piston block for compressing air to Combustion/expansion chamber

E—Piston to compress the air forward to Combustion/expansion chamber

F—Joint between piston and piston rod

G—Piston rod from piston to Converter wheel

H—Converter wheel

I—Joint between Intake piston rod and Converter wheel(picture 6)

J—Rotation joint of Converter wheel on Main Rotation axle,

K—Cogwheel connection between Converter wheel and Cylinder/piston blocks, to maintain synchronized stable velocity and rampage between all 3 rotating parts

L—Exhaust Cylinder/piston block where cylinders are X times larger in stroke volume/area than

Intake Cylinder/piston block's stroke volume/area

M—Exhaust gases from Exhaust Cylinder/piston block

N—As B, just at the other end

O—Expanded gasses/medium from Combustion/expansion chamber through manifold to Exhaust Cylinder/piston block

P—Excess power coming out of the engine, by the rotating arm

Q—Cogwheel between Cylinder/piston block and rotation arm to get the excess power out of the engine.

Z—Rod connecting Cylinder/piston blocks together for fully synchronized rotation, passing in between the openings in the Converter wheel
Picture 5—English
Manifold, where air/medium passage to/from cylinders in Cylinder/piston block take place, right under the Male manifold

10—Female manifold and its inner form, where air/medium passage to/from cylinders take place, right under Male manifold. Every quadrant is in direct connection to 1 cylinder

11—Male manifold sitting fixed to the engine shell, and sitting inside the Female manifold.

12—Piston and piston rod nearest center

13—Main Rotation axel, on which both Cylinder/piston blocks and Converter wheel rotate around. Main Rotation axel is fixed to the engine shell

14—Cylinder/piston block on the Main Rotation axel, rotating on ball bearings

15—Flow channels in the top of the Cylinder/piston block for passage of gases/medium, direct contact with the adjacent Female manifold.

16—Isolating areas between cylinder channel openings in Female manifold

17—Piston and piston rod longest away from the Main Rotation axel, with maximum stroke volume.
Picture 6, English
Piston rod joint before and on Converter wheel
G Piston Rod coming from a piston
I2 first joint on piston rod, before Converter wheel, that swings sideways
I1 second Joint between Piston Rod and converter wheel that allows rotation movement around
Converter Wheel
H Converter wheel in the middle of joint number 2

6A—Cut through picture

6B—Sideways picture

6C—Piston rod out of its joint
Picture 7—English
Manifold construction

18—Intake/exhaust channel in Male manifold

19—Isolating piece between intake and exhaust channels in Male manifold

20—Tightening rings on Male manifold

21—Air/medium intake/exhaust channel of cylinders

22—Isolating piece between cylinder intake/exhaust channels in Female manifold
Picture 7—English
NO 1 and 2: Shows manifolds away from each other
NO 3: Shows Male manifold fitting inside Female manifold. Tightening rings are not visible since now they are sitting inside

### DETAILED DESCRIPTION

The form of the engine with rotating Converter wheel with different rotation angel compare to the rotating engine block with pistons embedded inside where both rotate around the same rotation axel (In this case same main rotation axel). The main rotation axel of the system is the same, for both the converter wheel and the engine block, but rotations angels compare to the main rotation axel are different. The pistons in the engine block are in contact with converter wheel by piston rods.

The main rotation axel for different moving parts can be fixed to different places as well in this system, and does not have to go through the system.

This configuration is not though shown in our illustrations.

This engine/invention can be used in all kind of transportation vehicles and places where there is a need for production of kinetic energy and movement from a chemical reaction or physical agent.

Chemical agents like hydrocarbons or other matters that produces expansion of material or combinations of materials, physical agent like heat, light or other physical energy waves that produces expansion in the expansion chamber.

The engine can be used for movement of cars and other vehicles, motorcycles, bicycles, flying objects, and other apparatus.

Furthermore can this system be used in pumping of gasses and fluids in different systems for transporting fluids and gasses and to produce overpressure and under pressure, like in the refrigerator systems.

1. A volume based rotary piston engine comprising an intake cylinder/piston block to press air/medium toward a combustion/expansion chamber, the cylinder/piston block comprising a number of cylinders, pistons and piston rods, and connected to the cylinder/piston block there is a converter wheel, which converts piston movement to rotation of the converter wheel and rotation of the cylinder/piston block, wherein
the rotation angle of the converter wheel is different than that of the cylinder/piston block such that the distance between pistons and converter wheel varies according to the displacement, wherein
the piston rods are able to displace at the converter wheel in 2 different directions, both going around the converter wheel and sideways compared to the converter wheel, and wherein
the cylinder/piston block and the converter wheel have the same rotation speed, why all two parts are connected to each other with cogwheels and rods to maintain synchronization.

2. A volume based rotary piston engine comprising an intake cylinder/piston block to press air/medium toward a combustion/expansion chamber, the cylinder/piston block comprising a number of cylinders, pistons and piston rods, and connected to the cylinder/piston block there is a converter wheel, which converts piston movement to rotation of the converter wheel and rotation of the cylinder/piston block, wherein
the rotation angle of the converter wheel is different than that of the cylinder/piston block such that the distance between pistons and converter wheel varies according to the displacement, wherein
the piston rods are able to displace at the converter wheel in 2 different directions, both going around the converter wheel and sideways compared to the converter wheel, and wherein
the cylinder/piston block and the converter wheel have the same rotation speed, why all two parts are connected to each other with cogwheels and rods to maintain synchronization, and further comprising
an exhaust cylinder/piston block to harvest the energy form the reaction taking place in the combustion/expansion chamber, each cylinder/piston block comprising a number of cylinders, pistons and piston rods, and between the cylinder/piston blocks there is a converter wheel, which converts piston movement to rotation of the converter wheel and rotation of the cylinder/piston blocks, wherein
the rotation angle of the converter wheel is different than that of the cylinder/piston blocks such that the distance between pistons and converter wheel varies according to the displacement, wherein
the piston rods are able to displace at the converter wheel in 2 different directions, both going around the converter wheel and sideways compared to the converter wheel, wherein
the distance of the converter wheel to the pistons in the intake cylinder/piston block is less than the distance of the converter wheel to the pistons in the exhaust cylinder/piston block, and wherein
the cylinder/piston blocks and the converter wheel have the same rotation speed, why all three parts are connected to each other with cogwheels and rods to maintain synchronization.

3. A volume based rotary piston engine according to claim 2, wherein the exhaust cylinder/piston block has a larger stroke volume compared to the intake cylinder/piston block.

4. A volume based rotary piston engine according to claim 2, wherein the cylinder/piston blocks rotate around the same main rotation axle on ball bearings.

5. A volume based rotary piston engine according to claim 2, wherein a stabilizing rod is arranged between the cylinder/piston blocks.

6. A volume based rotary piston engine according to claim 1, wherein the combustion/expansion chamber comprises a catalyzator.

7. Use of an engine according to claim 1 for any one of pumping of gasses and fluids in different systems for transporting fluids and gasses, and producing overpressure and under pressure, like in the refrigerator systems.

8. Use of an engine according to claim 2 for any one of movement of cars and other vehicles, motorcycles, bicycles, flying objects, and other apparatus.

9. Use of an engine according to claim 2 in all kind of transportation vehicles and places where there is a need for production of kinetic energy and movement from a chemical reaction or physical agent.

10. A volume based rotary piston engine according to claim 2, wherein the combustion/expansion chamber comprises a catalyzator.

11. Use of an engine according to claim 2 for any one of pumping of gasses and fluids in different systems for transporting fluids and gasses, and producing overpressure and under pressure, like in the refrigerator systems.
